(19) United States
(12) Patent Application Publication
(10) Pub. No.: US 2013/0063394 A1
(43) Pub. Date: Mar. 14, 2013

(54) TACTILE STIMULUS GENERATION APPARATUS

(71) Applicant: Hiroshi Wakuda, Miyagi-ken (JP)

(72) Inventor: Hiroshi Wakuda, Miyagi-ken (JP)

(21) Appl. No.: 13/603,798

(22) Filed: Sep. 5, 2012

(30) Foreign Application Priority Data
Sep. 9, 2011 (JP) 2011-197328

(51) Int. Cl. G06F 3/044

(52) U.S. Cl. 345/174

(57) ABSTRACT

A tactile-stimulus generation apparatus is enabled to apply an electric stimulus to a fingertip of a user, and a tactile-stimulus generation sheet configured by arranging a tactile-sensation generation electrode group on an insulating layer is installed on a front surface of a capacitive type coordinate input device. The tactile-sensation generation electrode group is distributed at positions where tactile-sensation generation electrodes overlap first or second electrodes of the coordinate input device as seen in plan view. If the fingertip is in proximity with the insulating layer, the fingertip is capacitively coupled to positive and negative electrodes of the tactile sensation generation electrode group to which a differential voltage is applied, and thus, a portion of a current directing from the positive electrode to the negative electrode passes through the fingertip, so that an electric stimulus is applied to the user due to the current.

### CLAIM OF PRIORITY

This application claims benefit of Japanese Patent Application No. 2011-197328 filed on Sep. 9, 2011, which is hereby incorporated by reference in its entirety.

### BACKGROUND OF THE DISCLOSURE

1. Field of the Disclosure

The present disclosure relates to a tactile stimulus generation apparatus which is installed on a front surface of a coordinate input device called a touch panel or the like so as to apply a controlled electric stimulus to the fingertip of an operator (user), and more particularly, to a tactile stimulus generation apparatus which is very appropriate for a case where a detection method of the coordinate input device is of a capacitive type.

2. Description of the Related Art

A coordinate input device called a touch panel is configured so that, when a user causes a fingertip to be in contact with or in proximity to an operation surface, the coordinate input device detects a coordinate position of the fingertip and performing an input operation according to the coordinate position. In other words, such a coordinate input device is installed on a front surface of a display apparatus such as an LCD (liquid crystal display) and is configured so that, if the user places a fingertip on a desired operation area displayed on a screen of the display apparatus, operation content of the operation area is executed. In addition, with respect to a coordinate position detecting method of such a coordinate input device, there are known various types, for example, a capacitive type, a resistive film type, a surface acoustic wave type, and an electromagnetic induction type, and among these types, the capacitive type based on a change in capacitance value is widely employed (for example, refer to PCT Japanese Translation Patent Publication No. 2003-511799).

In a capacitive type coordinate input device, a detection electrode group configured with transparent electrodes is arranged on an operation surface. For example, PCT Japanese Translation Patent Publication No. 2003-511799 discloses a coordinate input device where a plurality of first strip-shaped electrodes extending along the Y axis and a plurality of second strip-shaped electrodes extending along the X axis are arranged in a lattice shape as seen in plan view to constitute a detection electrode group, and a coordinate position of a fingertip of a user can be detected by using a phenomenon that a capacitance value between the first strip-shaped electrode and the second strip-shaped electrode changes at the position where the fingertip is placed. PCT Japanese Translation Patent Publication No. 2003-511799 discloses a coordinate input device where a plurality of diamond-shaped transparent electrodes are uniformly distributed as seen in plan view to constitute a detection electrode group. In the case of the coordinate input device, the detection electrode group is configured by disposing a plurality of first diamond-shaped electrodes connected along the Y axis to be distributed at a regular interval along the X axis direction and arranging a plurality of second diamond-shaped electrodes connected along the X axis and not overlapping with the first diamond-shaped electrodes as seen in plan view to be distributed at a regular interval in the Y axis direction.

However, in such a coordinate input device, when a user causes their fingertip to be in contact with or in proximity to an operation surface, the user needs to check that the fingertip is placed at a desired position of the operation surface by visual recognition. In other words, when the fingertip of the user is placed at any position of the operation surface, no difference in sensation transferred to the fingertip occurs. Therefore, if the user inattentively visually recognizes the position of the fingertip on the operation surface, correct operation may become difficult.

Therefore, in the related art, a tactile stimulus generation apparatus is proposed which is configured to apply an electric stimulus to a fingertip of a user if the fingertip is in contact with a plurality of electrodes arranged on an operation surface (for example, refer to Japanese Unexamined Patent Application Publication No. 2004-319255). In the example of the related art, a plurality of electrodes are arranged in a checkerboard shape on the operation surface, and if the user presses down a desired position of the operation surface with the fingertip, the fingertip is allowed to be in contact with two or more electrodes, so that there is a change in electrical characteristics (impedance or the like) between a plurality of the electrodes, and thus, position detection can be performed. In addition, a predetermined pulse signal is supplied to a plurality of the electrodes so that the electric stimulus is applied to the fingertip of the user. Therefore, the user is allowed to sense the stimulus as a pseudo tactile sensation, and thus, it can be fed back to the user that the fingertip is in contact with the desired position of the operation surface.

In addition, as another example in the related art, a tactile stimulus generation apparatus is proposed where a low frequency (for example, 100 to 300 Hz) electric signal is applied from a high voltage source to an electrode covered with an insulating member, and a fingertip of a user which is allowed to be in contact with or in proximity to the insulating member is capacitively coupled to the electrode through the insulating member, so that a stimulus according to the electric signal can be sensed by the Pacinian corpuscles of the fingertip (for example, refer to Japanese Unexamined Patent Application Publication No. 2009-87359). In the example of the related art, since electric charges are excited at the fingertip of the user due to the capacitive coupling to the electrode, a variety of electric stimuli can be applied to the fingertip by controlling the frequency or the like of the electric signal.

However, in the tactile stimulus generation apparatus disclosed in Japanese Unexamined Patent Application Publication No. 2004-319255, since the electric stimulus is applied by allowing the fingertip of the user to be in contact with the electrode, electrical conduction may be prevented due to sweat, sebum, or the like adhered to the fingertip. Therefore, in the example of the related art, there are problems in that it is not easy to generate a desired tactile stimulus at the fingertip and high reliability cannot be expected. In addition, if the amount of current supplied is increased, the tactile stimulus can be securely generated even in the case where the electrical conduction is prevented due to the sebum or the like. However, in this case, there is a problem in that the electric stimulus applied to the fingertip is so strong that the user feels pain in the fingertip.

On the other hand, in the tactile stimulus generation apparatus disclosed in Japanese Unexamined Patent Application Publication No. 2009-87359, since the fingertip of the user is capacitively coupled to the electrode through the insulating member, in the case where the apparatus is installed on a front surface of a capacitive type coordinate input device, a capacitance value changes in a complicated manner due to the capacitive coupling between the electrode group of the tactile stimulus generation apparatus and the detection electrode group of the coordinate input device, so that the detection operation of the coordinate input device may be prevented due to its influence. Therefore, in order to use such a tactile stimulus generation apparatus together with the capacitive type coordinate input device, special measures need to be taken. However, Japanese Unexamined Patent Application Publication No. 2009-87359 makes no mention of the measures. In addition, in the example of the related art, when the fingertip is capacitively coupled to the electrode supplied with a high voltage (for example, 1 kV) electric signal in the state where a portion of the body of the user is in contact with a metal or the like to be earthed (grounded), abnormal current flows in the body of the user due to AC coupling according to a change in voltage of the high voltage electric signal, so that the user may be electrically shocked. Therefore, in terms of securing safety, there is a room for improvement in the related art.

### SUMMARY

A tactile stimulus generation apparatus, which is installed to be used on a front surface of a capacitive type coordinate input device which can detect a coordinate position of a specific body part of a user such as a fingertip when the specific body part is in proximity with the capacitive type coordinate input device and which applies an electric stimulus (tactile stimulus) to the specific body part, includes: a plurality of tactile sensation generation electrodes including positive electrodes and negative electrodes to which a differential voltage having a phase difference of 180 degrees is applied; and an insulating layer which is configured to extend at positions covering the plurality of the tactile sensation generation electrodes and allows the positive electrodes and the negative electrodes adjacent thereto to be capacitively coupled, wherein the plurality of the tactile sensation generation electrodes are disposed to be distributed at positions where the plurality of the tactile sensation generation electrodes overlap a detection electrode group arranged in the coordinate input device as seen in plan view, and the specific body part which is in proximity to or contact with the insulating layer is allowed to be capacitively coupled to the positive electrodes and the negative electrodes, so that the stimulus is generated.

Herein, in the case where the electric stimulus signal of the tactile sensation generation electrode is a pulse-shaped signal, since the stimulus signal has a high frequency component, AC coupling impedance at the specific body part which is capacitively (C) coupled to the tactile sensation generation electrode is decreased, so that a current can easily flow in the specific body part such as a fingertip. Therefore, during the application of the stimulus signal in a main body having a high frequency component (pulse driving component or the like), the current caused by a differential voltage due to the AC coupling (a portion of the current directing from the positive electrode to the negative electrode) passes through the specific body part such as a fingertip, so that the stimulus can be generated. On the other hand, in the case where the electric stimulus signal of the tactile sensation generation electrodes has a sine waveform signal or the like, since the stimulus signal has a low frequency component in comparison with the pulsed waveform signal, the AC coupling impedance at the specific body part which is capacitively (C) coupled to the tactile sensation generation electrodes is increased, so that a current cannot easily flow in the specific body part. Therefore, during the application of the stimulus signal in a main body having a low frequency component (sine waveform component or the like), a stimulus can be generated so that significant deformation of a skin is generated by a Coulomb force between the tactile sensation generation electrodes and the electric charges excited or charged in the specific body part.

Since the tactile sensation generation electrodes of the tactile stimulus generation apparatus having the aforementioned configuration are disposed to be distributed at the positions where the tactile sensation generation electrodes overlap the detection electrode group of the coordinate input device as seen in plan view, the tactile sensation generation electrodes become only a factor of increasing stray capacitance in the capacitive type coordinate input device. Therefore, if an increasing amount from initial capacitance is canceled, the coordinate input device can perform accurate position detection with removing influence of the tactile sensation generation electrodes. In addition, in the tactile stimulus generation apparatus, since the specific body part such as a fingertip of the user is capacitively coupled to the positive electrodes and the negative electrodes, to which the differential voltage is applied, through an insulating layer, even in the case where the frequency component of the stimulus signal is high like the positive driving signal or the like, besides the case where the frequency component of the stimulus signal is lower than that of the sine waveform signal or the like, the current flowing from the positive electrode into the specific body part does not almost leak into the body of the user, but the current flows out into the negative electrode. In other words, although the current flows in the specific body part such as a fingertip due to a locally-occurring voltage difference during the operation of the tactile stimulus generation apparatus, a total change in voltage is almost zero. Therefore, even in the case where a portion of the body of the user is in contact with a metal or the like so as to be earthed, there is no possibility of electric shock caused by an abnormal current flowing into the body of the user. In addition, since the stimulus caused by the current or excited charges based on the electric signal of which the intensity or frequency is controlled can be applied to the specific body part such as a fingertip, the user can be allowed to sense the stimulus according to the electric signal as a pseudo tactile sensation. In addition, since the user causes the specific body part such as a fingertip not to be in direct contact with the tactile sensation generation electrodes (positive electrode or negative electrode) during the operation, even in the case where sweat, sebum, or the like is adhered to the specific body part, significant influence is not exerted on the electric stimulus.

### BRIEF DESCRIPTION OF THE DRAWINGS

FIG. 1 is an exploded perspective view illustrating a tactile sensation generation electrode group of a tactile stimulus generation apparatus according to a first embodiment of the present invention together with a detection electrode group of a coordinate input device.

FIG. 2 is a schematic cross-sectional view illustrating main components of a laminated structure of the tactile sensation generation electrode group and the detection electrode group illustrated in FIG. 1.

FIG. 3 is a plan view illustrating an electrode pattern of an X-coordinate detection sheet illustrated in FIG. 1.

FIG. 4 is a plan view illustrating an electrode pattern of a Y-coordinate detection sheet illustrated in FIG. 1.

FIG. 5 is a plan view illustrating an electrode pattern of a tactile stimulus generation sheet illustrated in FIG. 1.

FIG. 6 is a circuit diagram illustrating a configuration of the tactile stimulus generation apparatus according to the first embodiment.

FIG. 7 is an explanation diagram illustrating the operating principle of the tactile stimulus generation sheet illustrated in FIG. 1.

FIG. 8 is an explanation diagram illustrating a modified example of the first embodiment corresponding to FIG. 5.

FIG. 9 is an exploded perspective view illustrating a tactile sensation generation electrode group of a tactile stimulus generation apparatus according to a second embodiment of the present invention together with a detection electrode group of a coordinate input device.

FIG. 10 is a plan view illustrating main components of the tactile stimulus generation apparatus illustrated in FIG. 9.

### DESCRIPTION OF THE EXEMPLARY EMBODIMENTS

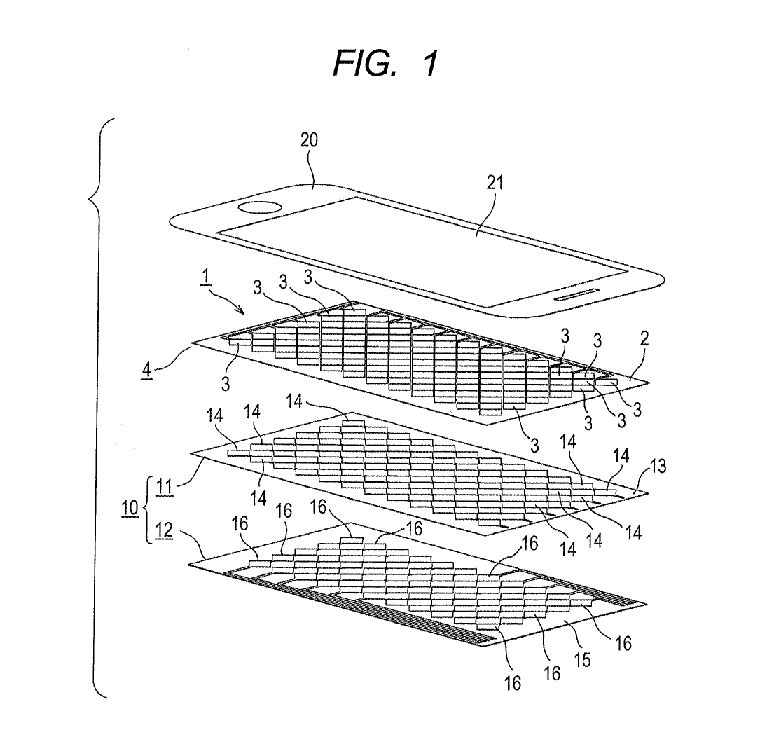

Hereinafter, embodiments of the present invention will be described with reference to the drawings. First, a first embodiment of the present invention will be described in detail with reference to FIGS. 1 to 7.

FIG. 1 illustrates a usage example in a case where a tactile stimulus generation sheet 4 of a tactile stimulus generation apparatus 1 according to the first embodiment is installed on a front surface (the upper side of the figure) of an X-coordinate detection sheet 11 and a Y-coordinate detection sheet 12 of a coordinate input device 10. The tactile stimulus generation sheet 4 is configured so that a plurality of tactile sensation generation electrodes 3 are arranged on one side of a transparent insulating layer 2 made of PET (polyethylene terephthalate) or the like. A transparent protection sheet 21 of a cover member 20 is disposed on the front surface of the tactile stimulus generation sheet 4, and the surface of the transparent protection sheet 21 becomes an operation surface. The detection method of the coordinate input device 10 is of a so-called capacitive type, and the X-coordinate detection sheet 11 and the Y-coordinate detection sheet 12 laminated on the front surface thereof cooperatively perform the coordination detection. The X-coordinate detection sheet 11 is installed on the front surface of a display apparatus (for example, an LCD) (not shown), and the tactile stimulus generation sheet 4 is disposed on the front surface of the Y-coordinate detection sheet 12.

The coordinate input device 10 is a sheet-shaped coordinate input device which is called a touch panel, a touch screen, or the like. If a user causes a fingertip thereof to be in contact with the operation surface (surface of the transparent protection sheet 21), the capacitance value changes, and thus, the coordinate position of the fingertip is detected, so that an input operation according to the coordinate position of the fingertip may be performed. In other words, if the user places the fingertip on a desired operation area displayed on a screen of the display apparatus such as an LCD, operation content of the operation area may be executed.

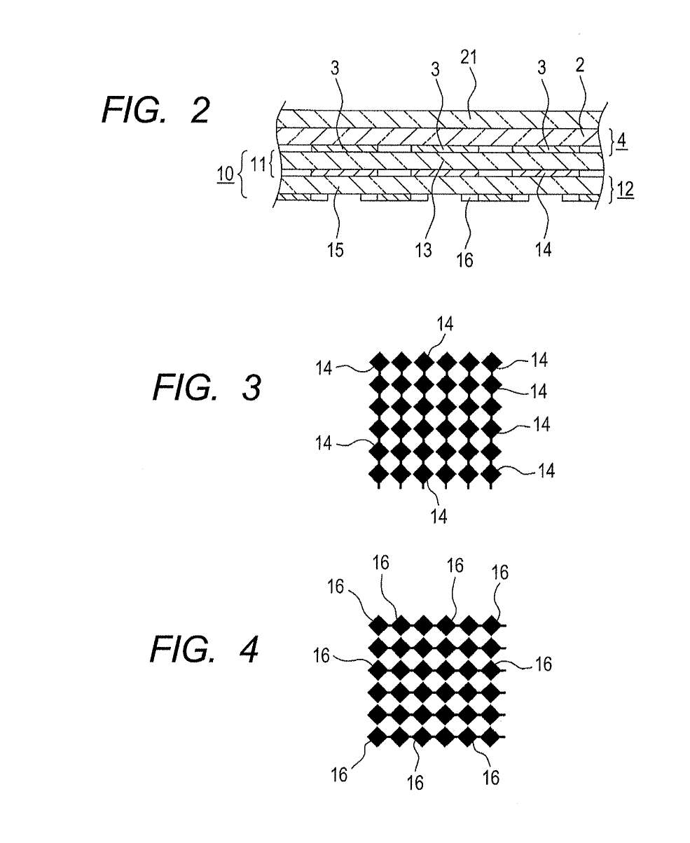

In the X-coordinate detection sheet 11 of the coordinate input device 10, a plurality of diamond-shaped first electrodes 14 are disposed on one side of a transparent insulating layer 13 made of PET or the like, and the first electrodes 14 as transparent electrodes are disposed in a uniform distribution so as to constitute a first detection electrode group. As illustrated in FIG. 3, in the first detection electrode group, the plurality of the first electrodes 14 are lined up and connected along the Y axis direction (longitudinal direction in the figure), and the lines of the first electrodes 14 are disposed to be distributed in a regular interval along the X axis direction (transverse direction in the figure). Therefore, the X coordinate of the fingertip on the operation surface can be detected based on detection data indicating which one of the lines of the first electrodes 14 interacts with the fingertip of the user. In addition, in the Y-coordinate detection sheet 12 of the coordinate input device 10, a plurality of diamond-shaped second electrodes 16 are disposed on one side of a transparent insulating layer 15 made of PET or the like, and the second electrodes 16 as transparent electrodes are disposed in a uniform distribution so as to constitute a second detection electrode group. As illustrated in FIG. 4, in the second detection electrode group, the plurality of the second electrodes 16 are lined up and connected along the X axis direction, and the lines of the second electrodes 16 are disposed to be distributed in a regular interval along the Y axis direction. Therefore, the Y coordinate of the fingertip on the operation surface can be detected based on detection data indicating which one of the lines of the second electrodes 16 interacts with the fingertip of the user.

In addition, all the first electrodes 14 of the X-coordinate detection sheet 11 and all the second electrodes 16 of the Y-coordinate detection sheet 12 are disposed so as not to overlap each other as seen in plan view. In other words, in the arrangement, the second electrodes 16 are respectively disposed at the backward side of the interstices between the adjacent first electrodes 14 in the first detection electrode group, and the first electrodes 14 are respectively disposed at the forward side of the interstices between the adjacent second electrodes 16 in the second detection electrode group. As described later, the tactile sensation generation electrodes 3 of the tactile stimulus generation sheet 4 are respectively arranged at positions which are indicated by projecting the first electrodes 14 and the second electrodes 16 in the forward direction. The three components of the first electrode 14, the second electrode 16, and the tactile sensation generation electrodes 3 are formed to be equal in shape and size.

In addition, since the detection principle of the coordinate input device 10 is well known publicly, detailed description thereof is omitted. If the user causes the fingertip to be in proximity with the coordinate input device 10, the capacitance value decreases between the first electrode 14 and the second electrode 16 in the vicinity of the fingertip, so that the coordinate position of the fingertip can be detected based on the change in capacitance value.

The tactile stimulus generation apparatus 1 is configured so as to apply a controlled electric stimulus (tactile stimulus) to the fingertip of which the coordinate position is detected by the coordinate input device 10, and thus, two or more circuits exemplarily illustrated in FIG. 6 are used to apply differential voltages to the tactile sensation generation electrode (3) group. In FIG. 6, Vin is a command signal in a range of ±2 V, and Vout is an electric signal in a range of ±2 kV, which is output to the tactile sensation generation electrodes 3. After a voltage difference between Vin of the command signal and GND (0 V) which is the reference voltage of an operational amplifier 6 is amplified by the operational amplifier 6, an output voltage of a drive circuit 7 is fed back through a feedback circuit 8 to be stabilized, so that a voltage according to a command value is output. The output of the drive circuit 7 is applied to the tactile sensation generation electrode (3) group through a resistor 9 which is connected to two inputs of the isolation amplifier 5. At this time, since a voltage difference occurring between the two ends of the resistor 9 is proportional to a current amount flowing in the resistor 9, with respect to a current amount flowing from the drive circuit 7 to the tactile sensation generation electrode (3) group, current information I is extracted by acquiring operation result of the isolation amplifier 5. Accordingly, a high voltage and a low voltage are applied to a positive side electrode and a negative side electrode constituting the tactile sensation generation electrode (3) group, respectively, so that the current information I flowing in the positive side electrode and the current information I flowing in the negative side electrode are extracted. When the current amount control is performed and the differential voltages are applied while monitoring the obtained current information I, the current amount flowing from the positive side electrode into the fingertip of the user and the current amount flowing out from the fingertip to the negative side electrode are equal to each other. For example, if a stimulus signal is a pulse-shaped signal, in the case where the current amount flowing into the fingertip of the user is decreased, the control of which an angle of a rising edge of the pulse is gentle is performed.

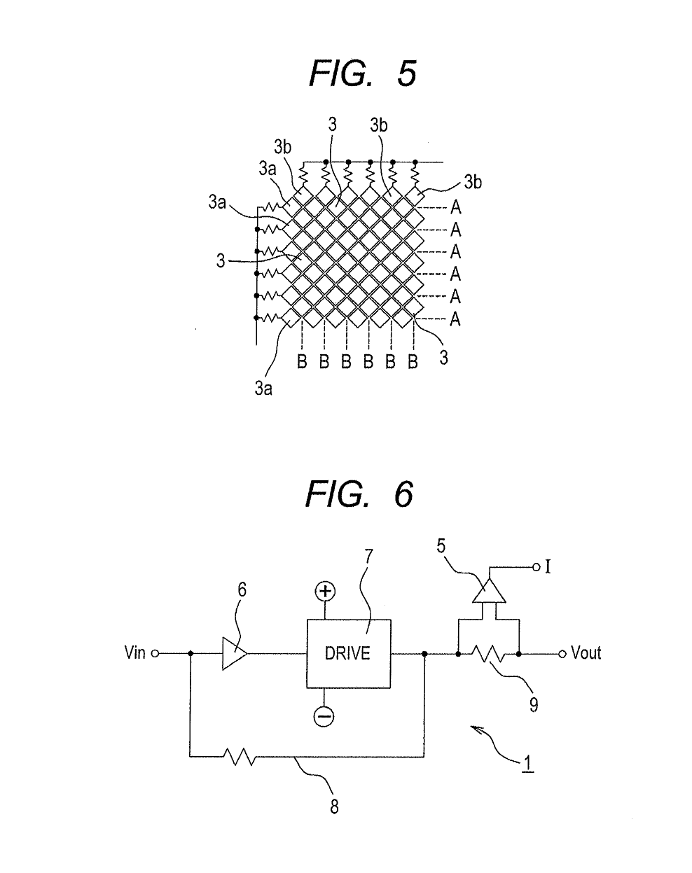

As illustrated in FIG. 5, in the tactile stimulus generation sheet 4, the diamond-shaped tactile sensation generation electrodes 3 configured with transparent electrodes are disposed to be distributed at a high density. Among the tactile sensation generation electrodes 3, the tactile sensation generation electrodes 3a located at the left end in FIG. 5 are disposed to be distributed along the Y axis direction (longitudinal direction in the figure), and the tactile sensation generation electrodes 3b located at the upper end in FIG. 5 are disposed to be distributed along the X axis direction (transverse direction in the figure). In addition, a differential voltage is configured to be applied to the tactile sensation generation electrode (3a) group and the tactile sensation generation electrode (3b) group. In FIG. 5, since the electrode line B of the tactile sensation generation electrodes 3 where the tactile sensation generation electrodes 3b are aligned at the leading end along the Y axis overlaps the line of the first electrodes 14 (refer to FIG. 3) which are aligned in the same direction as seen in plan view, if a voltage is applied to a tactile sensation generation electrode 3b, the same charges as those of the tactile sensation generation electrode 3b are excited in the remaining tactile sensation generation electrodes 3 of the electrode line B through the first electrodes 14. Similarly, since the electrode line A of the tactile sensation generation electrodes 3 where the tactile sensation generation electrodes 3a are aligned at the leading end along the X axis overlaps the line of the second electrodes 16 (refer to FIG. 4) which are aligned in the same direction as seen in plan view, if a voltage is applied to a tactile sensation generation electrode 3a, the same charges as those of the tactile sensation generation electrode 3a are excited in the remaining tactile sensation generation electrodes 3 of the electrode line A through the second electrodes 16 (refer to FIG. 2). In other words, the tactile sensation generation electrodes 3 are respectively arranged at positions which are indicated by projecting the first electrodes 14 and the second electrodes 16 in the forward direction, and the electrodes 3, 14, and 16 are formed in a diamond shape with the same size, so that the tactile sensation generation electrodes 3 can be easily capacitively coupled to the first electrodes 14 or the second electrodes 16.

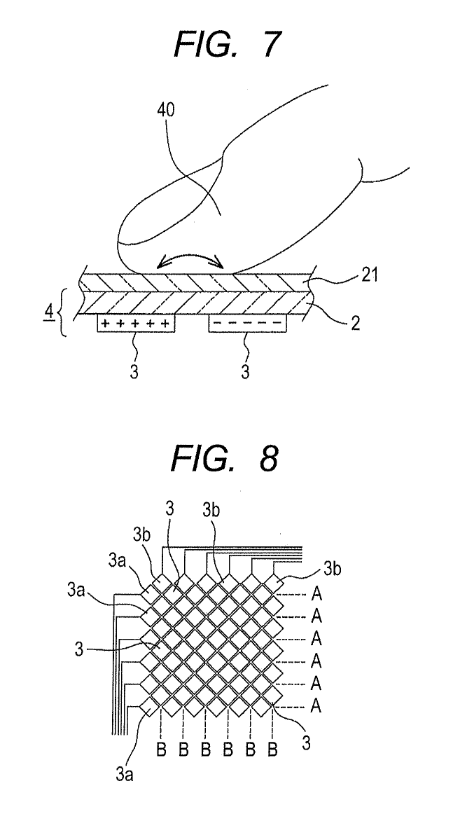

Next, operations of the tactile stimulus generation apparatus 1 having such a configuration will be described. As illustrated FIG. 7, if the user causes their fingertip 40 to be in contact with the operation surface (surface of the transparent protection sheet 21), the coordinate position of the fingertip 40 is detected by the coordinate input device 10. However, when the fingertip 40 is placed in a specific area of the operation surface, a predetermined electric stimulus (tactile stimulus) may be applied to the fingertip 40 according to the area by the tactile stimulus generation apparatus 1. Differential voltages having a phase difference of 180 degrees are alternately applied to the tactile sensation generation electrode (3) group, and thus, the electric stimulus is generated due to a current flowing in the fingertip 40 on the operation surface or charges excited on a skin of the finger.

In other words, if the differential voltages are applied, one of the aforementioned electrode line A and electrode line B constituting the tactile sensation generation electrode (3) group alternately becomes positive side electrodes relatively with respect to the other thereof, and the other becomes negative side electrodes. When the fingertip 40 of the user is not in proximity with the insulating layer 2 extending at the position covering the tactile sensation generation electrode (3) group, the positive side electrode and the negative side electrode adjacent thereto are capacitively coupled to each other through the insulating layer 2. However, as illustrated in FIG. 7, if the fingertip 40 is in contact with the operation surface (surface of the transparent protection sheet 21), the fingertip 40 is capacitively coupled to the positive side electrode 3 and the negative side electrode 3 in the vicinity thereof through the insulating layer 2 and the transparent protection sheet 21. As a result, a portion of the lines of electric force directing from the positive side electrode 3 to the negative side electrode 3 passes through the fingertip 40 due to the differential voltages, and thus, the electric stimulus (stimulus according to a current, excited charges, or mutual influence) may be applied to the fingertip 40. Since the electric stimulus signal is an electric signal (pulse signal or the like) of which the amplitude or the frequency is controlled by the tactile stimulus generation apparatus 1, the stimulus generated due to the current flowing in the fingertip 40 or the charges excited to the skin of the finger is allowed to be sensed as a pseudo tactile sensation by the user. For example, a tactile stimulus such as a click feeling can be easily allowed to be sensed. Therefore, if the tactile stimulus generation apparatus 1 is used together with the coordinate input device 10, information as to which area of the operation surface the fingertip 40 is placed on can be fed back to the user as a tactile stimulus.

As described hereinbefore, in the tactile stimulus generation apparatus 1 according to the embodiment, when the user causes the fingertip 40 to be in proximity with the insulating layer 2 of the tactile stimulus generation sheet 4, the fingertip 40 is capacitively coupled to the positive side electrode and the negative side electrode of the tactile sensation generation electrode (3) group to which the differential voltages are applied, so that the line of electric force (a portion of the AC current path directing from the positive side electrode to the negative side electrode) caused by the differential voltages passes through the fingertip 40. Therefore, the current from the positive side electrode into the fingertip 40 flows out to the negative side electrode with almost no leakage to the body of the user. In other words, although the current flows in the fingertip 40 due to a locally-occurring voltage difference during the operation of the tactile stimulus generation apparatus 1, a total change in voltage is almost zero. Therefore, even in the case where a portion of the body of the user is in contact with a metal or the like so as to be earthed, there is no possibility of electric shock caused by an abnormal current flowing into the body of the user, so that the tactile stimulus generation apparatus 1 having high safety can be configured.

In addition, in the embodiment, since the differential voltages are applied while performing the current amount control so that the current amount flowing from the positive side electrode of the tactile sensation generation electrode (3) group into the fingertip 40 on the operation surface is equal to the current amount flowing out from the fingertip 40 to the negative side electrode, even in the case where the body of the user is electrically charged, almost no change in voltage occurs at the fingertip 40 to which the electric stimulus is applied. Therefore, even in the case where the differential voltages applied to the tactile sensation generation electrodes 3 are set to slightly high in order to generate a strong tactile stimulus, there is no possibility that the user is electrically shocked. In other words, in the tactile stimulus generation apparatus 1, special consideration of safety measures has been made in order to prevent an electric shock accident.

In addition, in the tactile stimulus generation apparatus 1 according to the embodiment, since the user causes fingertip 40 not to be in direct contact with the tactile sensation generation electrodes 3 during the operation thereof, even in the case where sweat, sebum, or the like is adhered to the fingertip 40, significant influence is not exerted on the electric stimulus. Therefore, in the tactile stimulus generation apparatus 1, a desired tactile stimulus based on an electric signal of which the amplitude or frequency is appropriately set can be easily applied to the user, and high reliability can be obtained. In addition, if the tactile stimulus generation apparatus 1 is used together with the coordinate input device 10, information as to which area of the operation surface the fingertip 40 is placed on can be fed back to the user as a tactile stimulus, so that erroneous operations can be easily prevented, and the usability of the coordinate input device 10 is greatly improved. For example, even in the case where the user is a driver of a vehicle which is being driven, the user can correctly operate without neglecting paying attention to the forward visibility.

In addition, in the tactile stimulus generation apparatus 1 according to the embodiment, since the tactile sensation generation electrodes 3 are disposed to be distributed at the positions where the tactile sensation generation electrode (3) group overlaps the first and second detection electrode groups (first electrodes 14 or second electrodes 16) of the coordinate input device 10 as seen in plan view, the tactile sensation generation electrodes 3 become only a factor of increasing stray capacitance in the coordinate input device 10. In other words, if an increasing amount from initial capacitance is canceled, the coordinate input device 10 can perform accurate position detection with removing the influence of the tactile sensation generation electrodes 3, the tactile stimulus generation apparatus 1 is very appropriately used together with the capacitive type coordinate input device 10 in terms of the detection method.

Particularly, in the embodiment, the tactile sensation generation electrodes 3 are respectively arranged at positions which are indicated by projecting the first electrodes 14 and the second electrodes 16 of the coordinate input device 10 in the forward direction. The three components of the first electrodes 14, the second electrodes 16, and the tactile sensation generation electrodes 3 are formed to be equal in shape and size. Therefore, influence of the tactile sensation generation electrodes 3 on the coordinate input device 10 is not complicated, and thus, the aforementioned canceling process can be simply performed. In addition, since the tactile sensation generation electrodes 3 can be easily capacitively coupled to the facing first or second electrodes 14 or 16, it is possible to securely supply an electric signal to the tactile sensation generation electrodes 3 which are disposed to be distributed in a sequence through the first or second electrodes 14 of 16.

In addition, in the embodiment, since the tactile sensation generation electrodes 3 are formed in a diamond shape (in other words, the first electrodes 14 and the second electrodes 16 are also formed in a diamond shape), the tactile sensation generation electrodes 3 having a large size enough to be easily capacitively coupled to the first electrodes 14 or the second electrodes 16 can be arranged at a high density. Therefore, the tactile stimulus generation apparatus 1 can be allowed to easily apply a desired tactile stimulus to the fingertip 40 of the user at an arbitrary position of the operation surface.

In addition, in the aforementioned first embodiment, as illustrated in FIG. 5, when differential voltages are applied to the tactile sensation generation electrode (3) group, all the electrode lines A and all the electrode lines B alternately become the positive side electrode and the negative side electrode. Therefore, although the fingertip of the user is placed at any position of the operation surface, the tactile stimulus can be applied (however, the coordinate position of the fingertip can be detected by the coordinate input device 10). On the other hand, as illustrated in the modified example of FIG. 8, if it is configured so that the voltage can be applied to each line of the electrode lines A or the electrode lines B, only the specific electrode lines A and only the specific electrode lines B can be selected, and the differential voltages can be applied thereto. Therefore, for example, it can be set so that the tactile stimulus is applied to the fingertip placed at a predetermined area of the operation surface, and no tactile stimulus is applied to the other fingers placed at the other areas. In addition, if it is configured so that the voltage can be applied to each line of the electrode lines A or the electrode lines B, various types of electric signals (electric signals having different amplitudes or frequencies) for generating the tactile stimulus can be easily set for each area of the operation surface in advance.

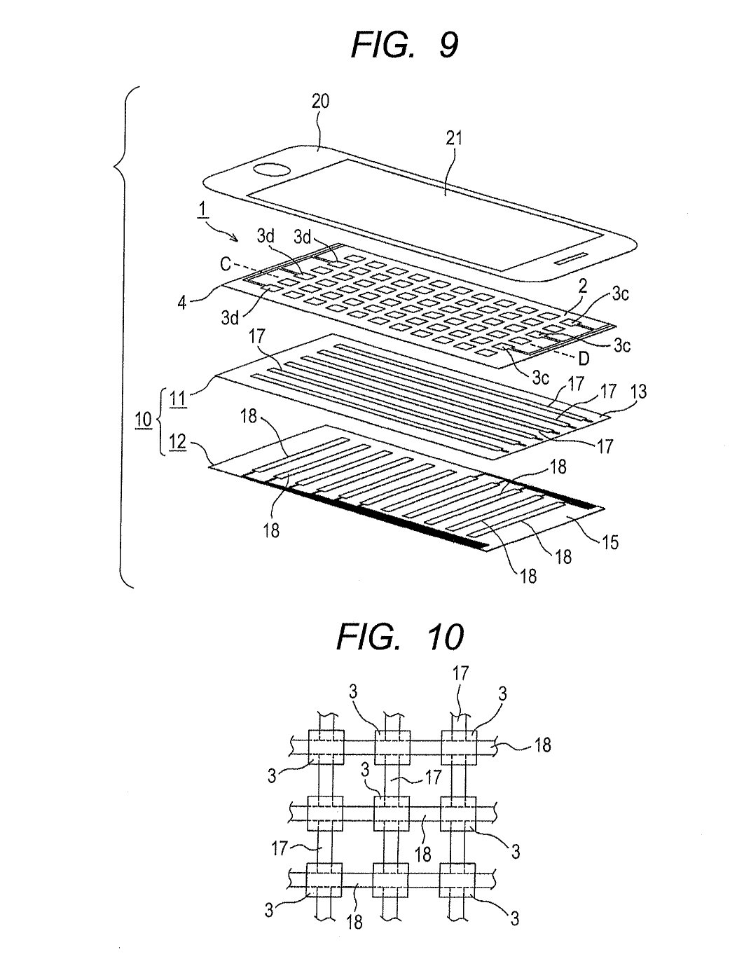

FIGS. 9 and 10 illustrate a usage example of a case where a tactile stimulus generation apparatus according to a second embodiment of the present invention is combined with a coordinate input device where a detection electrode group is patterned in a lattice shape as seen in plan view. The portions corresponding to those of FIG. 1 are denoted by the same reference numerals.

The position detection method of the coordinate input device 10 according to the second embodiment is also of a capacitive type. In the configuration, an X-coordinate detection sheet 11 is laminated on a Y-coordinate detection sheet 12, but detection electrode groups installed in the detection sheets 11 and 12 are formed in a line shape. In addition, a tactile stimulus generation sheet 4 is installed on the front surface of the Y-coordinate detection sheet 12, and a transparent protection sheet 21 of a cover member 20 is disposed on the front surface of the tactile stimulus generation sheet 4.

In the coordinate input device 10 illustrated in an exploded perspective view of FIG. 9 and a plan view of main components of FIG. 10, the detection electrode groups configured with transparent electrodes are configured to include: a first detection electrode group which is configured by disposing first strip-shaped electrodes 17 extending along the Y axis to be distributed in a regular interval along the X axis direction; and a second detection electrode group which is configured by disposing second strip-shaped electrodes 18 extending along the X axis to be distributed in a regular interval along the Y axis direction. The first strip-shaped electrodes 17 are arranged on one side of an insulating layer 13 of the X-coordinate detection sheet 11, and the second strip-shaped electrodes 18 are arranged on one side of an insulating layer 15 of the Y-coordinate detection sheet 12. In addition, through the lamination of the two detection sheets 11 and 12, the first strip-shaped electrodes 17 and the second strip-shaped electrodes 18 are arranged in a lattice shape as seen in plan view. In addition, the size of a unit cell of the lattice is set to be significantly smaller than that of the area which is covered with the fingertip of the user during the operation. Therefore, although the fingertip of the user is placed at any position of the operation surface (surface of the transparent protection sheet 21), the fingertip is necessarily placed in front of the first strip-shaped electrode 17 or the second strip-shaped electrode 18, the coordinate position can be detected at high accuracy.

In addition, in the second embodiment, a plurality of square-shaped tactile sensation generation electrodes 3 configured with transparent electrodes are disposed to be distributed at the position where the first strip-shaped electrodes 17 and the second strip-shaped electrodes 18 overlap each other as seen in plan view on one side of an insulating layer 2 of the tactile stimulus generation sheet 4. In the plurality of the tactile sensation generation electrodes 3, a plurality of tactile sensation generation electrodes 3c arranged at the right end of FIG. 9 and a plurality of tactile sensation generation electrodes 3d arranged at the left end are applied with differential voltages. The tactile sensation generation electrode (3) group is arranged so that an electrode line C of the tactile sensation generation electrodes 3 where the tactile sensation generation electrodes 3c are aligned at the leading end along the X axis and an electrode line D of the tactile sensation generation electrodes 3 where the tactile sensation generation electrodes 3d are aligned at the leading end along the X axis are aligned alternately in a regular interval along the Y axis direction. Therefore, if the differential voltages are applied to the tactile sensation generation electrodes 3c and 3d, through the second strip-shaped electrodes 18, one of the electrode line C and electrode line D becomes a line of positive side electrodes, and the other thereof becomes a line of negative side electrodes. In other words, if the differential voltages are applied, in the tactile sensation generation electrodes 3 which are aligned along the X axis like the electrode line C the electrode line D, due to the capacitively coupling to the second strip-shaped electrodes 18, the same charges as those of the tactile sensation generation electrodes 3c or 3d at the leading end are excited. Therefore, the tactile sensation generation electrode (3) group of the tactile stimulus generation sheet 4 is configured so that the lines of the positive side electrodes and the lines of the negative side electrodes are aligned alternately in a regular interval. Accordingly, the fingertip of the user placed on the transparent protection sheet 21 is capacitively coupled to the positive side electrode and the negative side electrode in the vicinity thereof, so that the current caused by the differential voltages (a portion of the current flowing from the positive side electrode to the negative side electrode) can be allowed to flow into the fingertip. In addition, a stimulus can be generated on a skin of the finger due to excited charges caused by the differential voltages. In other words, the tactile stimulus generation apparatus 1 according to the embodiment can apply an electric stimulus (tactile stimulus) according to the coordinate position to the fingertip of the user of which the coordinate position is detected by the coordinate input device 10 including the first and second strip-shaped electrodes 17 and 18.

In this manner, the detection electrode group of the capacitive type coordinate input device 10 is formed in a line shape, and the first strip-shaped electrodes 17 and the second strip-shaped electrodes 18 are arranged in a lattice shape as seen in plan view. In this case, the tactile stimulus generation sheet 4 according to the second embodiment is installed on the front surface of such a coordinate input device 10, so that a desired tactile stimulus can be applied to the fingertip which is larger than a unit cell of the lattice. In the second embodiment, since the tactile sensation generation electrode (3) group does not need to be arranged at a very high density, the tactile stimulus generation sheet 4 can be easily manufactured.

In addition, in the aforementioned second embodiment, the tactile sensation generation electrodes 3 are disposed at the positions covering the areas (intersection areas) where the first and second strip-shaped electrodes 17 and 18 intersect each other. However, if any strip-shaped electrodes 17 and 18 have a relation of substantially symmetric positions, the tactile sensation generation electrodes 3 may be configured to overlap the first strip-shaped electrodes 17 or the second strip-shaped electrodes 18 at the positions which are shifted from the aforementioned intersection areas as seen in plan view.

It should be understood by those skilled in the art that various modifications, combinations, sub-combinations and alterations may occur depending on design requirements and other factors insofar as they are within the scope of the appended claims of the equivalents thereof.

What is claimed is:

1. A tactile stimulus generation apparatus which is installed to be used on a front surface of a capacitive type coordinate input device which can detect a coordinate position of a body part of a user when the body part is in proximity with the capacitive type coordinate input device and which applies an electric stimulus to the body part, comprising:
a plurality of tactile sensation generation electrodes including positive electrodes and negative electrodes to which a differential voltage having a phase difference of 180 degrees is applied; and
an insulating layer configured to extend at positions covering the plurality of the tactile sensation generation electrodes and allows the positive electrodes and the negative electrodes adjacent thereto to be capacitively coupled,
wherein the plurality of the tactile sensation generation electrodes are distributed at positions where the plurality of the tactile sensation generation electrodes overlap a detection electrode group arranged in the coordinate input device as seen in plan view, and the body part which is in proximity to or contact with the insulating layer is allowed to be capacitively coupled to the positive electrodes and the negative electrodes, so that the stimulus is generated.

2. The tactile stimulus generation apparatus according to claim 1,
wherein the detection electrode group of the coordinate input device includes a first detection electrode group formed of a plurality of first electrodes connected in a line along the Y axis direction and distributed in a regular interval along the X axis direction and a second detection electrode group formed of a plurality of second electrodes connected in a line along the X axis direction and distributed side by side in a regular interval along the Y axis direction,
wherein the first electrodes and the second electrodes are distributed not to overlap each other as seen in plan view, and the tactile sensation generation electrodes are formed in the same shape and size as those of the first electrodes and the second electrodes, and
wherein the tactile sensation generation electrodes are respectively arranged at positions to which the first electrodes and the second electrodes are projected in the forward direction.

3. The tactile stimulus generation apparatus according to claim 2, wherein each of the first electrodes, the second electrodes, and the tactile sensation generation electrodes is formed in a diamond shape.

4. The tactile stimulus generation apparatus according to claim 1,
wherein the detection electrode group of the coordinate input device includes a first detection electrode group where first strip-shaped electrodes extending along the X axis are distributed in a regular interval along the X axis direction and a second detection electrode group where second strip-shaped electrodes extending along the X axis are distributed in a regular interval along the Y axis direction, and
wherein the tactile sensation generation electrodes are disposed along with the first strip-shaped electrodes and the second strip-shaped electrodes so that lines of the positive electrodes and lines of the negative electrodes are alternately aligned in a regular interval along the X axis direction or the Y axis direction.
